(19) United States
(12) Patent Application Publication
(10) Pub. No.: US 2023/0238570 A1
(43) Pub. Date: Jul. 27, 2023

(54) ELECTROLYTE COMPOSITION FOR BATTERIES

(71) Applicant: GM GLOBAL TECHNOLOGY OPERATIONS LLC, Detroit, MI (US)

(72) Inventors: Chuanlong Wang, Ferndale, MI (US); Xiaosong Huang, Novi, MI (US)

(73) Assignee: GM GLOBAL TECHNOLOGY OPERATIONS LLC, Detroit, MI (US)

(21) Appl. No.: 17/586,035

(22) Filed: Jan. 27, 2022

(51) Int. Cl. H01M 10/056; H01M 10/0525

(52) U.S. Cl. CPC H01M 10/056; H01M 10/0525; H01M 2300/0034; H01M 2004/027

(57) ABSTRACT

An electrolyte composition for a battery is provided. The electrolyte composition includes a lithium salt in a carbonate-based solution and lithium difluoro(oxalate)borate present in the electrolyte composition in an amount from 0.1 part by weight to 5 parts by weight based on 100 parts by weight of the electrolyte composition.

### INTRODUCTION

The disclosure generally relates to an electrolyte composition for batteries.

Battery cells may include an anode, a cathode, an electrolyte composition, and a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A battery cell includes an electrolyte composition which provides lithium-ion conduction paths between the anode and the cathode. The electrolyte is an ionic conductor. The electrolyte is additionally an electronically insulating material.

Hybrid electric and full electric (collectively “electric-drive”) powertrains take on various architectures, some of which utilize a battery system to supply power for one or more electric traction motors.

### SUMMARY

An electrolyte composition for a battery is provided. The electrolyte composition includes a lithium salt in a carbonate-based solution. The electrolyte solution further includes lithium difluoro(oxalate)borate present in the electrolyte composition in an amount from 0.1 part by weight to 5 parts by weight based on 100 parts by weight of the electrolyte composition.

In some embodiments, the lithium difluoro(oxalate)borate is present in the electrolyte composition in an amount from 0.5 parts by weight to 1.5 parts by weight based on 100 parts by weight of the electrolyte composition.

In some embodiments, the lithium difluoro(oxalate)borate is present in the electrolyte composition in an amount of 1 part by weight based on 100 parts by weight of the electrolyte composition.

In some embodiments, the electrolyte composition further includes fluoroethylene carbonate present in the electrolyte composition in an amount from 1 part by weight to 10 parts by weight based on 100 parts by weight of the electrolyte composition. The electrolyte composition further includes vinylene carbonate present in the electrolyte composition in an amount from 1 part by weight to 10 parts by weight based on 100 parts by weight of the electrolyte composition.

In some embodiments, the electrolyte composition further includes fluoroethylene carbonate present in the electrolyte composition in an amount of 2 parts by weight based on 100 parts by weight of the electrolyte composition. The electrolyte composition further includes vinylene carbonate present in the electrolyte composition in an amount of 1 part by weight based on 100 parts by weight of the electrolyte composition.

In some embodiments, the lithium salt includes lithium hexafluorophosphate present in an amount of 1 mole per 1 liter of the carbonate-based solution.

In some embodiments, the lithium salt is selected from the group consisting of lithium hexafluorophosphate, lithium tetrafluoroborate, lithium bis(trifluoromethanesulfonyl)imide, lithium bis(oxalato)borate, and lithium perchlorate. The lithium salt is present in an amount from 0.5 moles to 1.5 moles per 1 liter of the carbonate-based solution.

In some embodiments, the carbonate-based solution includes ethylene carbonate and dimethyl carbonate present in a ratio of 3 parts ethylene carbonate to 7 parts dimethyl carbonate.

In some embodiments, the carbonate-based solution includes two solvents selected from the group consisting of dimethyl carbonate, diethyl carbonate, ethylene carbonate, and propylene carbonate. The two solvents are present in a mixing ratio of from 1:9 to 9:1.

In some embodiments, the lithium difluoro(oxalate)borate is present in the electrolyte composition in an amount from 0.5 parts by weight to 1.5 parts by weight based on 100 parts by weight of the electrolyte composition. The lithium salt includes lithium hexafluorophosphate present in an amount from 0.5 moles to 2 moles per 1 liter of the carbonate-based solution. The carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate.

In some embodiments, the lithium difluoro(oxalate)borate is present in the electrolyte composition in an amount from 0.5 parts by weight to 1.5 parts by weight based on 100 parts by weight of the electrolyte composition. The lithium salt includes lithium hexafluorophosphate present in an amount from 0.5 moles to 2 moles per 1 liter of the carbonate-based solution. The carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate. The electrolyte composition further includes fluoroethylene carbonate present in the electrolyte composition in an amount from 1 part by weight to 5 parts by weight based on 100 parts by weight of the electrolyte composition. The electrolyte composition further includes vinylene carbonate present in the electrolyte composition in an amount from 1 part by weight to 5 parts by weight based on 100 parts by weight of the electrolyte composition.

According to one alternative embodiment, a battery is provided. The battery includes an anode, a cathode, and an electrolyte composition. The electrolyte composition includes a lithium salt in a carbonate-based solution. The electrolyte solution further includes lithium difluoro(oxalate)borate present in the electrolyte composition in an amount from 0.1 part by weight to 5 parts by weight based on 100 parts by weight of the electrolyte composition.

In some embodiments, the anode is a silicon-based anode.

In some embodiments, the silicon-based anode includes a material selected from the group consisting of silicon, silicon monoxide, Si/C and LixSiO, and a silicon blend with graphite.

In some embodiments, the cathode is a nickel-based cathode.

In some embodiments, the nickel-based cathode is a mixture including a material selected from the group consisting of a nickel-cobalt-manganese-aluminum mixture, a nickel-manganese-cobalt mixture, and a nickel-cobalt-aluminum mixture. The mixture further includes a material selected from the group consisting of olivine LiMnₓFe₁-xPO₄, lithium-iron-phosphate, and lithium manganese (III,IV) oxide.

In some embodiments, the lithium difluoro(oxalate)borate is present in the electrolyte composition in an amount from 0.5 parts by weight to 1.5 parts by weight based on 100 parts by weight of the electrolyte composition. The lithium salt includes lithium hexafluorophosphate present in an amount from 0.5 moles to 2 moles per 1 liter of the carbonate-based solution. The carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate.

In some embodiments, the lithium difluoro(oxalate)borate is present in the electrolyte composition in an amount from 0.5 parts by weight to 1.5 parts by weight based on 100 parts by weight of the electrolyte composition. The lithium salt includes lithium hexafluorophosphate present in an amount from 0.5 moles to 2 moles per 1 liter of the carbonate-based solution. The carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate. The electrolyte composition further includes fluoroethylene carbonate present in the electrolyte composition in an amount from 1 part by weight to 5 parts by weight based on 100 parts by weight of the electrolyte composition. The electrolyte composition further includes vinylene carbonate present in the electrolyte composition in an amount from 1 part by weight to 5 parts by weight based on 100 parts by weight of the electrolyte composition.

According to one alternative embodiment, a device is provided. The device includes an output component and a battery configured for providing electrical energy to the device. The battery includes an anode, a cathode, and an electrolyte composition. The electrolyte composition includes a lithium salt in a carbonate-based solution. The electrolyte composition further includes lithium difluoro(oxalate)borate present in the electrolyte composition in an amount from 0.1 part by weight to 5 parts by weight based on 100 parts by weight of the electrolyte composition.

In some embodiment, the lithium difluoro(oxalate)borate is present in the electrolyte composition in an amount from 0.5 parts by weight to 1.5 parts by weight based on 100 parts by weight of the electrolyte composition. The lithium salt includes lithium hexafluorophosphate present in an amount from 0.5 moles to 2 moles per 1 liter of the carbonate-based solution. The carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary battery including the disclosed electrolyte composition, in accordance with the present disclosure;

FIG. 2 schematically illustrates an exemplary device embodied by a vehicle equipped with the battery of FIG. 1, in accordance with the present disclosure;

FIG. 3A is a graph illustrating exemplary test results of a relationship between capacity of a battery and a number of operation cycles through which the battery is operated for a plurality of electrolyte compositions, in accordance with the present disclosure;

FIG. 3B is a graph illustrating exemplary test results of a relationship between capacity retention of a battery and a number of operation cycles through which the battery is operated for a plurality of electrolyte compositions, in accordance with the present disclosure;

FIG. 4 is a graph illustrating exemplary test results of a relationship between capacity of a battery and a number of operation cycles through which the battery is operated for a plurality of electrolyte compositions, in accordance with the present disclosure;

FIG. 5 is a graph illustrating exemplary test results of a relationship between capacity retention of a battery and a number of operation cycles through which the battery is operated for a plurality of electrolyte compositions, in accordance with the present disclosure;

FIG. 6 is a graph illustrating exemplary test results describing electrochemical impedance of a battery with a control electrolyte composition at three different operation states, in accordance with the present disclosure;

FIG. 7 is a graph illustrating exemplary test results describing electrochemical impedance of a battery with a baseline electrolyte composition at three different operation states, in accordance with the present disclosure;

FIG. 8 is a graph illustrating exemplary test results describing electrochemical impedance of a battery with a control electrolyte including LiDFOB included at 1% by weight at three different operation states, in accordance with the present disclosure;

FIG. 9 is a graph illustrating exemplary test results describing electrochemical impedance of a battery operating with a plurality of electrolyte compositions, in accordance with the present disclosure; and

FIG. 10 is a graph illustrating exemplary test results describing electrochemical impedance of a battery operating with a plurality of electrolyte compositions, in accordance with the present disclosure.

### DETAILED DESCRIPTION

During operation of a battery, chemical reactions taking place between the anode and the electrolyte composition cause a solid electrolyte interphase (SEI) layer to be formed upon an anode. Similarly, chemical reactions taking place between the cathode and the electrolyte composition cause a cathode electrolyte interphase (CEI) layer to be formed upon a cathode. The SEI layer and the CEI layer form as films upon the anode and cathode, respectively.

Increased stability in the SEI layer and the CEI layer may provide excellent useful life or increased electrode capacity retention in the anode and cathode, respectively.

Lithium hexafluorophosphate (LiPF₆) based electrolyte compositions in use within a battery may develop reactive species, such as hydrofluoric acid (HF). HF may interfere with interfacial structures of electrodes and cause degradation of the electrode surface that may contribute to capacity reduction over multiple operation cycles of the battery.

A cathode may be nickel based and may include manganese. Over multiple operation cycles of the battery, nickel and manganese may suffer from dissolution or may leach out of the cathode, thereby contributing to capacity reduction of the battery.

An electrolyte composition disclosed herein provides excellent cycle life for a battery. The battery may include a silicon-based anode and a nickel-based or nickel-rich cathode. In one embodiment, the electrolyte composition may include 1 molar or 1M LiPF₆ in an ethylene carbonate (EC)/dimethyl carbonate (DMC) (3:7) solution. In one embodiment, the electrolyte composition may include excellent cycle performance and capacity retention by further including lithium difluoro(oxalate)borate (LiDFOB) at 1.0% by weight. In another embodiment, the electrolyte may include excellent cycle performance and capacity retention by further including LiDFOB at 1.0% by weight, and by further including fluoroethylene carbonate (FEC) at 2.0% by weight and vinylene carbonate (VC) at 1.0% by weight.

The carbonate-based solution may include ethylene carbonate and dimethyl carbonate present in a ratio of 3 parts ethylene carbonate to 7 parts dimethyl carbonate.

The electrolyte composition may include fluoroethylene carbonate present in the electrolyte composition in an amount from 1 part by weight to 10 parts by weight based on 100 parts by weight of the electrolyte composition. The electrolyte composition may include vinylene carbonate present in the electrolyte composition in an amount from 1 part by weight to 10 parts by weight based on 100 parts by weight of the electrolyte composition.

The electrolyte composition may include fluoroethylene carbonate present in the electrolyte composition in an amount of 2 parts by weight based on 100 parts by weight of the electrolyte composition. The electrolyte composition may include vinylene carbonate present in the electrolyte composition in an amount of 1 part by weight based on 100 parts by weight of the electrolyte composition.

An electrolyte composition for a battery is provided. The electrolyte composition includes a lithium salt in a carbonate-based solution. The electrolyte solution further includes lithium difluoro(oxalate)borate present in the electrolyte composition in an amount from 0.1 part by weight to 5 parts by weight based on 100 parts by weight of the electrolyte composition. The lithium difluoro(oxalate)borate may be present in the electrolyte composition in an amount of 1 part by weight based on 100 parts by weight of the electrolyte composition. The lithium difluoro(oxalate)borate may be present in the electrolyte composition in an amount of 1 part by weight based on 100 parts by weight of the electrolyte composition.

A number of alternatives to the electrolyte composition are provided. Throughout the disclosure, the solvent EC/DMC in a 3:7 solution may be substituted with various carbonate-based solvents. These carbonate-based solvents may include, without being limited to, two of the following: DMC, diethyl carbonate (DEC), EC, and propylene carbonate (PC). The electrolyte may include a mixture of two of the above carbonate solvents in various mixing ratios in a range from 1:9 to 9:1. The electrolyte compositions can include various types of lithium salt. Throughout the disclosure, 1M LiPF₆ may be substituted with various lithium salts. At least one lithium salt can include, without being limited to, LiPF₆, lithium tetrafluoroborate (LiBF₄), lithium bis(trifluoromethanesulfonyl)imide (LiTFSI), lithium bis(oxalato)borate (LiBOB), and lithium perchlorate (LiClO₄). The concentration of the lithium salt in the electrolyte can vary from 0.5M to 1.5M. In one embodiment, the disclosed electrolyte composition may include, without being limited to, 1M LiPF₆ in EC/DMC 3:7 with a LiDFOB additive and/or 1M LiBF₄ in EC/DEC 3:7 with a LiDFOB additive.

The lithium salt may include lithium hexafluorophosphate present in an amount of 1 mole per 1 liter of the carbonate-based solution.

The lithium salt may be selected from the group consisting of lithium hexafluorophosphate, lithium tetrafluoroborate, lithium bis(trifluoromethanesulfonyl)imide, lithium bis(oxalato)borate, and lithium perchlorate. The lithium salt may be present in an amount from 0.5 moles to 1.5 moles per 1 liter of the carbonate-based solution.

The carbonate-based solution may include two solvents selected from the group consisting of dimethyl carbonate, diethyl carbonate, ethylene carbonate, and propylene carbonate. The two solvents may be present in a mixing ratio of from 1:9 to 9:1.

The lithium difluoro(oxalate)borate may be present in the electrolyte composition in an amount from 0.5 parts by weight to 1.5 parts by weight based on 100 parts by weight of the electrolyte composition. The lithium salt may include lithium hexafluorophosphate present in an amount from 0.5 moles to 2 moles per 1 liter of the carbonate-based solution. The carbonate-based solution may include ethylene carbonate and dimethyl carbonate present in a ratio ranging from 2 parts ethylene carbonate to 8 parts dimethyl carbonate to 5 parts ethylene carbonate to 5 parts dimethyl carbonate.

The lithium difluoro(oxalate)borate may be present in the electrolyte composition in an amount from 0.5 parts by weight to 1.5 parts by weight based on 100 parts by weight of the electrolyte composition. The lithium salt may include lithium hexafluorophosphate present in an amount from 0.5 moles to 2 moles per 1 liter of the carbonate-based solution. The carbonate-based solution may include ethylene carbonate and dimethyl carbonate present in a ratio ranging from 2 parts ethylene carbonate to 8 parts dimethyl carbonate to 5 parts ethylene carbonate to 5 parts dimethyl carbonate. The electrolyte composition may further include fluoroethylene carbonate present in the electrolyte composition in an amount from 1 part by weight to 5 parts by weight based on 100 parts by weight of the electrolyte composition. The electrolyte composition may further include vinylene carbonate present in the electrolyte composition in an amount from 1 part by weight to 5 parts by weight based on 100 parts by weight of the electrolyte composition.

The disclosed electrolyte composition may be utilized with a variety of battery configurations. In one exemplary battery configuration, the anode of the battery may include a silicon-based anode, for example, including silicon (Si) and/or silicon monoxide (SiO) and/or modified Si/SiO (i.e., carbon coated Si/SiO) or a Si-carbon compound (Si/C). In another exemplary battery configuration, the cathode of the battery may include a nickel-based anode or nickel-rich cathode, for example, including relatively high levels of nickel (Ni). In another exemplary battery configuration, the anode of the battery may include a silicon-based anode, and the cathode of the battery may include a nickel-based anode or nickel-rich cathode. In another exemplary battery configuration, the anode of the battery may include Si, SiO, LixSiO, Si/C or a blend of these materials with graphite. In another exemplary battery configuration, the cathode of the battery may include a nickel-cobalt-manganese-aluminum mixture (NCMA), a nickel-manganese-cobalt mixture (NMC), a nickel-cobalt-aluminum mixture (NCA), olivine LiMnₓFe₁-xPO₄ (LMFP), a lithium, iron, phosphate mixture (LFP), lithium manganese (III,IV) oxide (LiMn₂O₄ or LMO), or a blend of these materials.

The inclusion of LiDFOB in the disclosed electrolyte composition includes a plurality of benefits. Presence of LiDFOB in the disclosed concentration range promotes formation of a stable interphase upon the anode and the cathode. LiDFOB may sacrificially decompose and form stable electrode/electrolyte interphases (containing inorganic boron, fluorine, and carbonate compounds.)

Presence of LiDFOB in the disclosed concentration range promotes scavenging of HF within the electrolyte composition or reduces presence of HF in the electrolyte composition. LiDFOB may sequester phosphorus pentafluoride PF₅ (from lithium hexafluorophosphate (LiPF₆) salt), which may reduce an amount of HF formation. HF may consume Li ions to form lithium fluoride (LiF) which may be deposited on a surface of the electrodes.

Presence of LiDFOB in the disclosed concentration range mitigates dissolution or migration of nickel and manganese in the cathode.

The disclosed electrolyte composition may be utilized in a wide variety of batteries, including but not limited to lithium-ion, lithium-metal, lithium sulfur/oxygen batteries.

A battery is provided. The battery includes an anode, a cathode, and an electrolyte composition. The electrolyte composition includes a lithium salt in a carbonate-based solution. The electrolyte solution further includes lithium difluoro(oxalate)borate present in the electrolyte composition in an amount from 0.1 part by weight to 5 parts by weight based on 100 parts by weight of the electrolyte composition.

The anode may be a silicon-based anode.

The silicon-based anode may include a material selected from the group consisting of silicon, silicon monoxide, Si/C and LixSiO, and a silicon blend with graphite.

The cathode may be a nickel-based cathode.

The nickel-based cathode may be a mixture including a material selected from the group consisting of a nickel-cobalt-manganese-aluminum mixture, a nickel-manganese-cobalt mixture, and a nickel-cobalt-aluminum mixture. The mixture may further include a material selected from the group consisting of olivine LiMnₓFe₁-xPO₄, lithium-iron-phosphate, and lithium manganese (III,IV) oxide.

The lithium difluoro(oxalate)borate may be present in the electrolyte composition in an amount from 0.5 parts by weight to 1.5 parts by weight based on 100 parts by weight of the electrolyte composition. The lithium salt may include lithium hexafluorophosphate present in an amount from 0.5 moles to 2 moles per 1 liter of the carbonate-based solution. The carbonate-based solution may include ethylene carbonate and dimethyl carbonate present in a ratio ranging from 2 parts ethylene carbonate to 8 parts dimethyl carbonate to 5 parts ethylene carbonate to 5 parts dimethyl carbonate.

The lithium difluoro(oxalate)borate may be present in the electrolyte composition in an amount from 0.5 parts by weight to 1.5 parts by weight based on 100 parts by weight of the electrolyte composition. The lithium salt may include lithium hexafluorophosphate present in an amount from 0.5 moles to 2 moles per 1 liter of the carbonate-based solution. The carbonate-based solution may include ethylene carbonate and dimethyl carbonate present in a ratio ranging from 2 parts ethylene carbonate to 8 parts dimethyl carbonate to 5 parts ethylene carbonate to 5 parts dimethyl carbonate. The electrolyte composition may further include fluoroethylene carbonate present in the electrolyte composition in an amount from 1 part by weight to 5 parts by weight based on 100 parts by weight of the electrolyte composition. The electrolyte composition may further include vinylene carbonate present in the electrolyte composition in an amount from 1 part by weight to 5 parts by weight based on 100 parts by weight of the electrolyte composition.

A device is provided. The device includes an output component and a battery configured for providing electrical energy to the device. The battery includes an anode, a cathode, and an electrolyte composition. The electrolyte composition includes a lithium salt in a carbonate-based solution. The electrolyte composition further includes lithium difluoro(oxalate)borate present in the electrolyte composition in an amount from 0.1 part by weight to 5 parts by weight based on 100 parts by weight of the electrolyte composition. The device may be a vehicle.

The lithium difluoro(oxalate)borate may be present in the electrolyte composition in an amount from 0.5 parts by weight to 1.5 parts by weight based on 100 parts by weight of the electrolyte composition. The lithium salt may include lithium hexafluorophosphate present in an amount from 0.5 moles to 2 moles per 1 liter of the carbonate-based solution. The carbonate-based solution may include ethylene carbonate and dimethyl carbonate present in a ratio ranging from 2 parts ethylene carbonate to 8 parts dimethyl carbonate to 5 parts ethylene carbonate to 5 parts dimethyl carbonate.

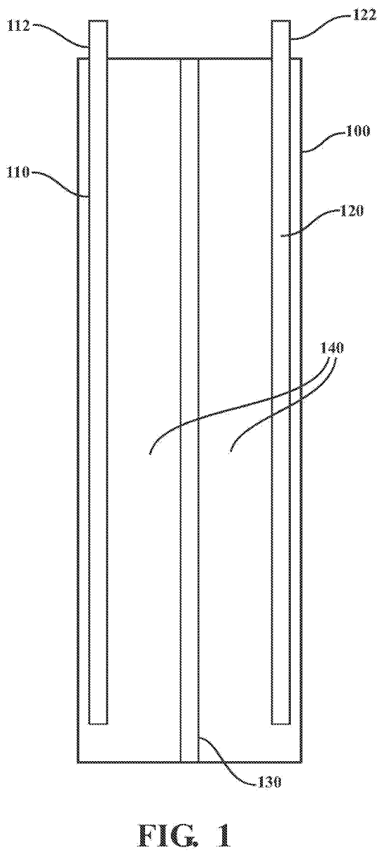

Referring now to the drawings, wherein like reference numbers refer to like features throughout the several views, FIG. 1 schematically illustrates an exemplary battery cell 100, including an anode 110, a cathode 120, a separator 130, and an electrolyte composition 140. The battery cell 100 enables converting electrical energy into stored chemical energy in a charging cycle, and the battery cell 100 enable converting stored chemical energy into electrical energy in a discharging cycle. A negative current collector 112 is illustrated connected to the anode 110, and a positive current collector 122 is illustrated connected to the cathode 120. The separator 130 is operable to separate the anode 110 from the cathode 120 and to enable ion transfer through the separator 130. The electrolyte composition 140 is a liquid or gel that provides a lithium-ion conduction path between the anode 110 and the cathode 120.

The anode 110 may be constructed of a silicon-based substance. The cathode 120 may be constructed of a nickel-based substance. In one embodiment, the cathode 120 may be constructed of a nickel manganese cobalt (NMC) substance.

The electrolyte composition 140 may include EC/DEC/EMC in a 1:1:1 composition. The electrolyte composition 140 the electrolyte composition may include 1 molar or 1M LiPF₆ in an ethylene carbonate (EC)/dimethyl carbonate (DMC) (3:7) solution. In one embodiment, the electrolyte composition may include excellent cycle performance and capacity retention by further including lithium difluoro(oxalate)borate (LiDFOB) at 1.0% by weight. In another embodiment, the electrolyte may include excellent cycle performance and capacity retention by further including LiDFOB at 1.0% by weight, and by further including fluoroethylene carbonate (FEC) at 2.0% by weight and vinylene carbonate (VC) at 1.0% by weight.

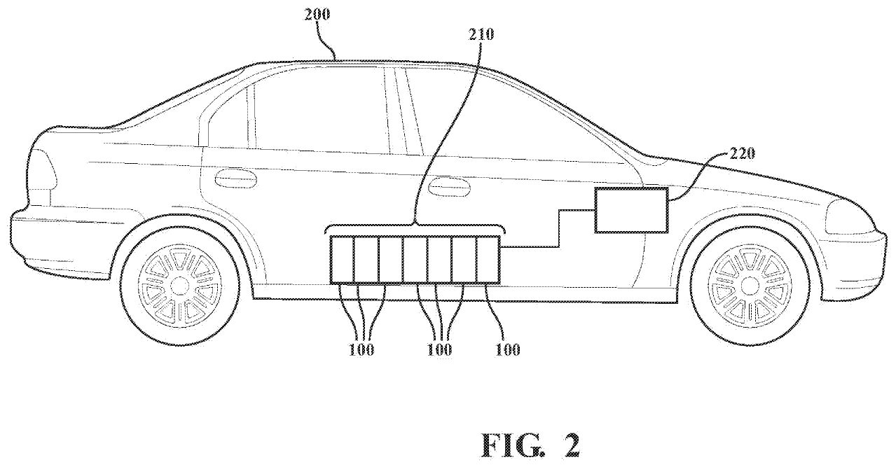

The battery cell 100 may be utilized in a wide range of applications and powertrains. FIG. 2 schematically illustrates an exemplary device 200, e.g., a battery electric vehicle (BEV), including a battery pack 210 that includes a plurality of battery cells 100. The plurality of battery cells 100 may be connected in various combinations, for example, with a portion being connected in parallel and a portion being connected in series, to achieve goals of supplying electrical energy at a desired voltage. The battery pack 210 is illustrated as electrically connected to a motor generator unit 220 useful to provide motive force to the vehicle 200. The motor generator unit 220 may include an output component, for example, an output shaft, which is provided mechanical energy useful to provide the motive force to the vehicle 200. A number of variations to vehicle 200 are envisioned, and the disclosure is not intended to be limited to the examples provided.

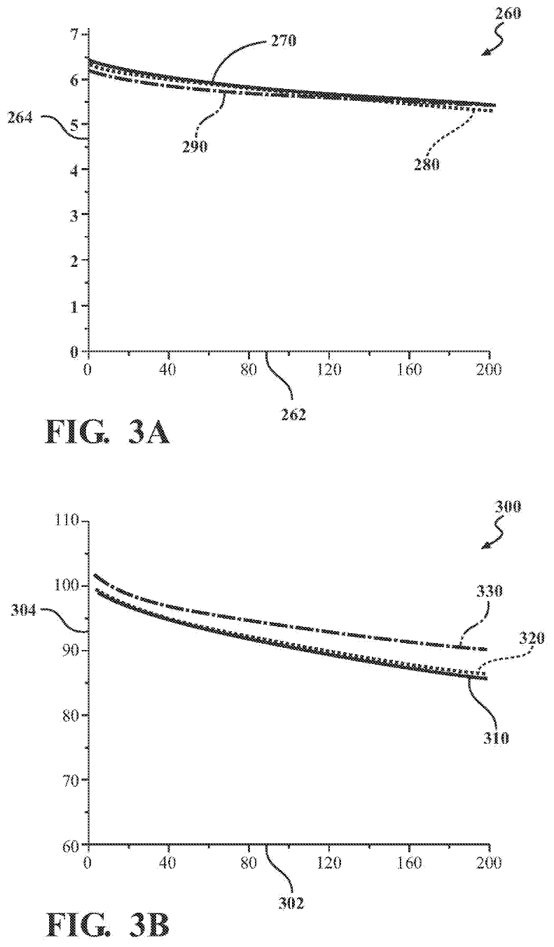

FIG. 3A is a graph 260 illustrating exemplary test results of a relationship between capacity of a battery and a number of operation cycles through which the battery is operated for a plurality of electrolyte compositions. A vertical axis 264 is illustrated describing a capacity of the cell in milliAmp hours. A horizontal axis 262 is illustrated describing the number of operation cycles. The anode active components include 5.5% SiO and 94.5% graphite. The cathode active material includes NCMA (˜5.0 milliamp hours per square centimeter.) Both the anode and the cathode additionally include binder and conductive fillers. Plot 270 illustrates a control electrolyte composition including 1M LiPF₆ in EC/DMC (3:7). Plot 280 illustrates a baseline electrolyte, which includes the control electrolyte plus FEC at 2% by weight and VC at 1% by weight. Plot 290 illustrates the control electrolyte plus LiDFOB at 1% by weight.

FIG. 3B is a graph 300 illustrating exemplary test results of a relationship between capacity retention of a battery and a number of operation cycles through which the battery is operated for a plurality of electrolyte compositions. A vertical axis 304 is illustrated describing a capacity retention of the cell as a percentage of an original cell capacity. A horizontal axis 302 is illustrated describing the number of operation cycles. The anode active components include 5.5% SiO and 94.5% graphite. The cathode active material includes NCMA (˜5.0 milliamp hours per square centimeter.) Both the anode and the cathode additionally include binder and conductive fillers. Plot 310 illustrates a control electrolyte composition including 1M LiPF₆ in EC/DMC (3:7). Plot 320 illustrates a baseline electrolyte, which includes the control electrolyte plus FEC at 2% by weight and VC at 1% by weight. Plot 330 illustrates the control electrolyte plus LiDFOB at 1% by weight. One may see a significant improvement in battery capacity retention in plot 330, which illustrates an improvement in cell capacity retention as a result of an inclusion of LiDFOB at 1% by weight.

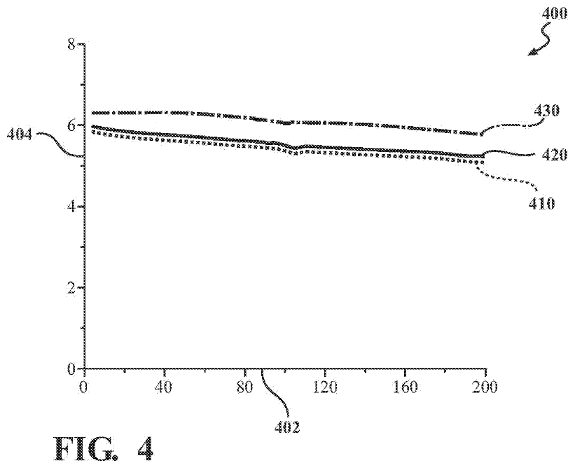

FIG. 4 is a graph 400 illustrating exemplary test results of a relationship between capacity of a battery and a number of operation cycles through which the battery is operated for a plurality of electrolyte compositions. A vertical axis 404 is illustrated describing a capacity of the battery in milliamp hours. A horizontal axis 402 is illustrated describing the number of operation cycles. The anode active components include 20% LixSiO and 80% graphite. The cathode active material includes NCMA (˜5.0 milliamp hours per square centimeter.) Both the anode and the cathode additionally include binder and conductive fillers. Plot 410 illustrates a control electrolyte composition including 1M LiPF₆ in EC/DMC (3:7). Plot 420 illustrates a baseline electrolyte, which includes the control electrolyte plus FEC at 2% by weight and VC at 1% by weight. Plot 430 illustrates the control electrolyte plus LiDFOB at 1% by weight. One may see a significant improvement in battery capacity retention in plot 430, which illustrates an improvement in battery capacity as a result of an inclusion of LiDFOB at 1% by weight.

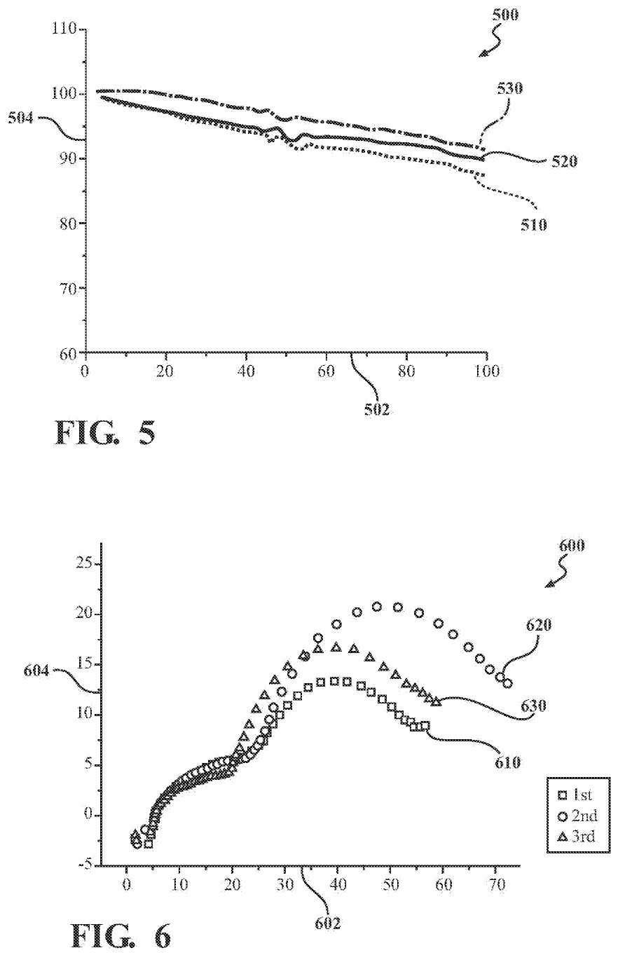

FIG. 5 is a graph 500 illustrating exemplary test results of a relationship between capacity retention of a battery and a number of operation cycles through which the battery is operated for a plurality of electrolyte compositions. A vertical axis 504 is illustrated describing a capacity retention of the battery as a percentage of an original battery capacity. A horizontal axis 502 is illustrated describing the number of operation cycles. The anode active components include 20% LixSiO and 80% graphite. The cathode active material includes NCMA (˜5.0 milliamp hours per square centimeter.) Both the anode and the cathode additionally include binder and conductive fillers. Plot 510 illustrates a control electrolyte composition including 1M LiPF₆ in EC/DMC (3:7). Plot 520 illustrates a baseline electrolyte, which includes the control electrolyte plus FEC at 2% by weight and VC at 1% by weight. Plot 530 illustrates the control electrolyte plus LiDFOB at 1% by weight. One may see a significant improvement in battery capacity retention in plot 530, which illustrates an improvement in battery capacity retention as a result of an inclusion of LiDFOB at 1% by weight.

FIG. 6 is a graph 600 illustrating exemplary test results describing electrochemical impedance spectroscopy (EIS) of a battery with a control electrolyte composition at three different operation states. The axes represent Nyquist plots representing negative of the imaginary (vertical axis 604) versus real parts (horizontal axis 602) of the complex impedance of individual electrodes or electrochemical cells. The anode active components include 5.5% SiO and 94.5% graphite. The cathode active material includes NCMA (˜5.0 milliamp hours per square centimeter.) Both the anode and the cathode additionally include binder and conductive fillers. The control electrolyte composition includes 1M LiPF₆ in EC/DMC (3:7). Plot 610 illustrates impedance of the battery at a first state or point in operation, where the battery operates through 3 formation cycles at 1/20^{th} of a current capacity of the battery (C/20 and the voltage before testing is maintained at 4.2 Volts). Plot 620 illustrates impedance of the battery at a second state or point in operation, where the battery has been held at 4.2 Volts for 20 hours. Plot 630 illustrates impedance of the battery at a third state or point in operation, where the battery operates past the second state through an additional 3 cycles at C/20 and the voltage before testing is maintained at 4.2 Volts.

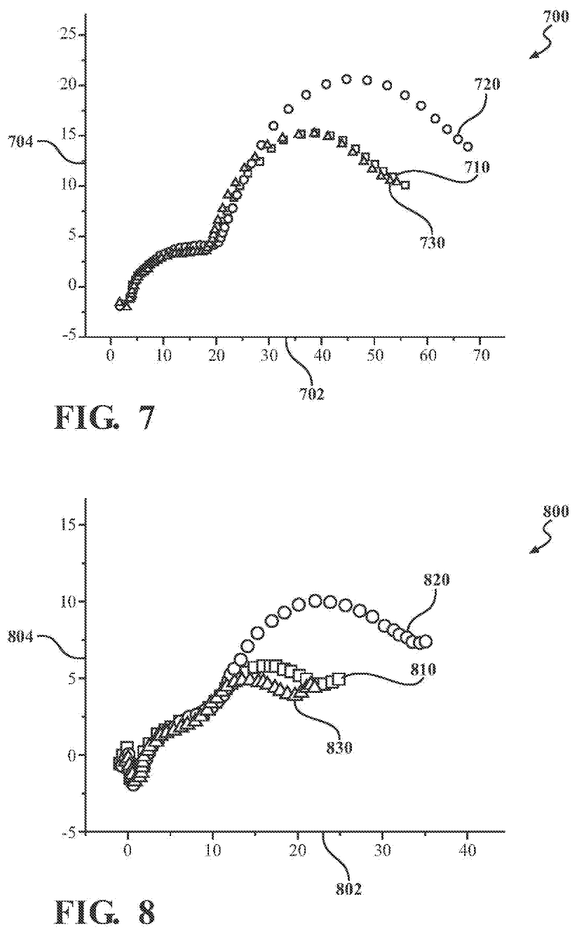

FIG. 7 is a graph 700 illustrating exemplary test results describing EIS of a battery with a baseline electrolyte composition at three different operation states. The axes represent Nyquist plots representing negative of the imaginary (vertical axis 704) versus real parts (horizontal axis 702) of the complex impedance of individual electrodes or electrochemical cells. The anode active components include 5.5% SiO and 94.5% graphite. The cathode active material includes NCMA (˜5.0 milliamp hours per square centimeter.) Both the anode and the cathode additionally include binder and conductive fillers. The baseline electrolyte composition includes including 1M LiPF₆ in EC/DMC (3:7) plus FEC at 2% by weight and VC at 1% by weight. Plot 710 illustrates impedance of the battery at a first state or point in operation, where the battery operates through 3 formation cycles at C/20 and the voltage before testing is maintained at 4.2 Volts. Plot 720 illustrates impedance of the battery at a second state or point in operation, where the battery has been held at 4.2 Volts for 20 hours. Plot 730 illustrates impedance of the battery at a third state or point in operation, where the cell operates past the second state through an additional 3 cycles at C/20 and the voltage before testing is maintained at 4.2 Volts.

FIG. 8 is a graph 800 illustrating exemplary test results describing EIS of a battery with a control electrolyte including LiDFOB included at 1% by weight at three different operation states. The axes represent Nyquist plots representing negative of the imaginary (vertical axis 804) versus real parts (horizontal axis 802) of the complex impedance of individual electrodes or electrochemical cells. The anode active components include 5.5% SiO and 94.5% graphite. The cathode active material includes NCMA (˜5.0 milliamp hours per square centimeter.) Both the anode and the cathode additionally include binder and conductive fillers. The electrolyte composition includes 1M LiPF₆ in EC/DMC (3:7) plus LiDFOB at 1% by weight. Plot 810 illustrates impedance of the battery at a first state or point in operation, where the battery operates through 3 formation cycles at C/20 and the voltage before testing is maintained at 4.2 Volts. Plot 820 illustrates impedance of the battery at a second state or point in operation, where the battery has been held at 4.2 Volts for 20 hours. Plot 830 illustrates impedance of the battery at a third state or point in operation, where the battery operates past the second state through an additional 3 cycles at C/20 and the voltage before testing is maintained at 4.2 Volts. Comparing the results of FIGS. 6-8 illustrating similar test results for three different electrolyte compositions, one may see decreased impedance with the electrolyte composition including LiDFOB at 1% by weight.

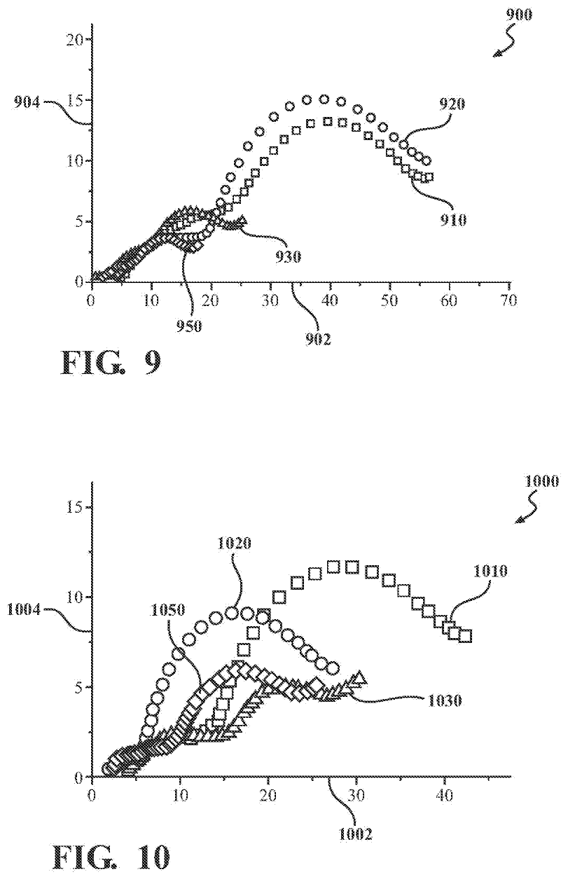

FIG. 9 is a graph 900 illustrating exemplary test results describing EIS of a battery operating with a plurality of electrolyte compositions. The axes represent Nyquist plots representing negative of the imaginary (vertical axis 904) versus real parts (horizontal axis 902) of the complex impedance of individual electrodes or electrochemical cells. The anode active components include 5.5% SiO and 94.5% graphite. The cathode active material includes NCMA (˜5.0 milliamp hours per square centimeter.) Both the anode and the cathode additionally include binder and conductive fillers. The EIS is measured after 3 formation cycles at C/20. Plot 910 illustrates impedance of the battery including a control electrolyte composition including 1M LiPF₆ in EC/DMC (3:7). Plot 920 illustrates impedance of the battery including a baseline electrolyte composition including the control electrolyte composition plus FEC at 2% by weight and VC at 1% by weight. Plot 930 illustrates impedance of the battery including the control electrolyte composition plus LiDFOB at 1% by weight. Plot 950 illustrates impedance of the battery including the control electrolyte composition plus FEC at 2% by weight, VC at 1% by weight, and LiDFOB at 1% by weight. Comparing the results of plots 910, 920, 930, and 950, one may see further decreased impedance with the electrolyte composition including FEC at 2%, VC at 1% and LiDFOB at 1% by weight.

FIG. 10 is a graph 1000 illustrating exemplary test results describing EIS of a battery operating with a plurality of electrolyte compositions. The axes represent Nyquist plots representing negative of the imaginary (vertical axis 1004) versus real parts (horizontal axis 1002) of the complex impedance of individual electrodes or electrochemical cells. The anode active components include 20% LixSiO and 80% graphite. The cathode active material includes NCMA (˜5.0 milliamp hours per square centimeter.) Both the anode and the cathode additionally include binder and conductive fillers. The EIS is measured after 3 formation cycles at C/20. Plot 1010 illustrates impedance of the battery including a control electrolyte composition including 1M LiPF₆ in EC/DMC (3:7). Plot 1020 illustrates impedance of the battery including a baseline electrolyte composition including the control electrolyte composition plus FEC at 2% by weight and VC at 1% by weight. Plot 1030 illustrates impedance of the battery including the control electrolyte composition plus LiDFOB at 1% by weight. Plot 1050 illustrates impedance of the battery including the control electrolyte composition plus FEC at 2% by weight, VC at 1% by weight, and LiDFOB at 1% by weight. Comparing the results of plots 1010, 1020, 1030, and 1050, one may see further decreased impedance with the electrolyte composition including FEC at 2%, VC at 1% and LiDFOB at 1% by weight.

While the best modes for carrying out the disclosure have been described in detail, those familiar with the art to which this disclosure relates will recognize various alternative designs and embodiments for practicing the disclosure within the scope of the appended claims.

What is claimed is:

1. An electrolyte composition for a battery, the electrolyte composition comprising:
a lithium salt in a carbonate-based solution; and
lithium difluoro(oxalate)borate present in the electrolyte composition in an amount from 0.1 part by weight to 5 parts by weight based on 100 parts by weight of the electrolyte composition.

2. The electrolyte composition of claim 1, wherein the lithium difluoro(oxalate)borate is present in the electrolyte composition in an amount from 0.5 parts by weight to 1.5 parts by weight based on 100 parts by weight of the electrolyte composition.

3. The electrolyte composition of claim 1, wherein the lithium difluoro(oxalate)borate is present in the electrolyte composition in an amount of 1 part by weight based on 100 parts by weight of the electrolyte composition.

4. The electrolyte composition of claim 2, further comprising:
fluoroethylene carbonate present in the electrolyte composition in an amount from 1 part by weight to 10 parts by weight based on 100 parts by weight of the electrolyte composition; and
vinylene carbonate present in the electrolyte composition in an amount from 1 part by weight to 10 parts by weight based on 100 parts by weight of the electrolyte composition.

5. The electrolyte composition of claim 2, further comprising:
fluoroethylene carbonate present in the electrolyte composition in an amount of 2 parts by weight based on 100 parts by weight of the electrolyte composition; and
vinylene carbonate present in the electrolyte composition in an amount of 1 part by weight based on 100 parts by weight of the electrolyte composition.

6. The electrolyte composition of claim 1, wherein the lithium salt includes lithium hexafluorophosphate present in an amount of 1 mole per 1 liter of the carbonate-based solution.

7. The electrolyte composition of claim 1, wherein the lithium salt is selected from the group consisting of lithium hexafluorophosphate, lithium tetrafluoroborate, lithium bis(trifluoromethanesulfonyl)imide, lithium bis(oxalato)borate, and lithium perchlorate; and
wherein the lithium salt is present in an amount from 0.5 moles to 1.5 moles per 1 liter of the carbonate-based solution.

8. The electrolyte composition of claim 1, wherein the carbonate-based solution includes ethylene carbonate and dimethyl carbonate present in a ratio of 3 parts ethylene carbonate to 7 parts dimethyl carbonate.

9. The electrolyte composition of claim 1, wherein the carbonate-based solution includes two solvents selected from the group consisting of dimethyl carbonate, diethyl carbonate, ethylene carbonate, and propylene carbonate; and
wherein the two solvents are present in a mixing ratio of from 1:9 to 9:1.

10. The electrolyte composition of claim 1, wherein the lithium difluoro(oxalate)borate is present in the electrolyte composition in an amount from 0.5 parts by weight to 1.5 parts by weight based on 100 parts by weight of the electrolyte composition;
wherein the lithium salt includes lithium hexafluorophosphate present in an amount from 0.5 moles to 2 moles per 1 liter of the carbonate-based solution; and
wherein the carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate.

11. The electrolyte composition of claim 1, wherein the lithium difluoro(oxalate)borate is present in the electrolyte composition in an amount from 0.5 parts by weight to 1.5 parts by weight based on 100 parts by weight of the electrolyte composition;
wherein the lithium salt includes lithium hexafluorophosphate present in an amount from 0.5 moles to 2 moles per 1 liter of the carbonate-based solution; and
wherein the carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate; and
wherein the electrolyte composition further comprises:
fluoroethylene carbonate present in the electrolyte composition in an amount from 1 part by weight to 5 parts by weight based on 100 parts by weight of the electrolyte composition; and
vinylene carbonate present in the electrolyte composition in an amount from 1 part by weight to 5 parts by weight based on 100 parts by weight of the electrolyte composition.

12. A battery comprising:
an anode;
a cathode; and
an electrolyte composition including:
a lithium salt in a carbonate-based solution; and
lithium difluoro(oxalate)borate present in the electrolyte composition in an amount from 0.1 part by weight to 5 parts by weight based on 100 parts by weight of the electrolyte composition.

13. The battery of claim 12, wherein the anode is a silicon-based anode.

14. The battery of claim 13, wherein the silicon-based anode includes a material selected from the group consisting of silicon, silicon monoxide, Si/C and LixSiO, and a silicon blend with graphite.

15. The battery of claim 12, wherein the cathode is a nickel-based cathode.

16. The battery of claim 15, wherein the nickel-based cathode is a mixture including:
a material selected from the group consisting of a nickel-cobalt-manganese-aluminum mixture, a nickel-manganese-cobalt mixture, and a nickel-cobalt-aluminum mixture; and
a material selected from the group consisting of olivine LiMnₓFe₁-xPO₄, lithium-iron-phosphate, and lithium manganese (III,IV) oxide.

17. The battery of claim 12, wherein the lithium difluoro(oxalate)borate is present in the electrolyte composition in an amount from 0.5 parts by weight to 1.5 parts by weight based on 100 parts by weight of the electrolyte composition;
wherein the lithium salt includes lithium hexafluorophosphate present in an amount from 0.5 moles to 2 moles per 1 liter of the carbonate-based solution; and
wherein the carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate.

18. The battery of claim 12, wherein the lithium difluoro(oxalate)borate is present in the electrolyte composition in an amount from 0.5 parts by weight to 1.5 parts by weight based on 100 parts by weight of the electrolyte composition;
wherein the lithium salt includes lithium hexafluorophosphate present in an amount from 0.5 moles to 2 moles per 1 liter of the carbonate-based solution; and
wherein the carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate; and
wherein the electrolyte composition further includes:
fluoroethylene carbonate present in the electrolyte composition in an amount from 1 part by weight to 5 parts by weight based on 100 parts by weight of the electrolyte composition; and
vinylene carbonate present in the electrolyte composition in an amount from 1 part by weight to 5 parts by weight based on 100 parts by weight of the electrolyte composition.

19. A device comprising:
an output component; and
a battery configured for providing electrical energy to the device, the battery including:
an anode;
a cathode; and
an electrolyte composition including:
a lithium salt in a carbonate-based solution; and
lithium difluoro(oxalate)borate present in the electrolyte composition in an amount from 0.1 part by weight to 5 parts by weight based on 100 parts by weight of the electrolyte composition.

20. The device of claim 19, wherein the lithium difluoro(oxalate)borate is present in the electrolyte composition in an amount from 0.5 parts by weight to 1.5 parts by weight based on 100 parts by weight of the electrolyte composition;
wherein the lithium salt includes lithium hexafluorophosphate present in an amount from 0.5 moles to 2 moles per 1 liter of the carbonate-based solution; and
wherein the carbonate-based solution includes ethylene carbonate and dimethyl carbonate present in a ratio ranging from 2 parts ethylene carbonate to 8 parts dimethyl carbonate to 5 parts ethylene carbonate to 5 parts dimethyl carbonate.
